(19) United States
(12) Patent Application Publication
(10) Pub. No.: US 2007/0277299 A1
(43) Pub. Date: Dec. 6, 2007

(54) SYSTEMS AND METHODS FOR SMOKELESS TOBACCO STORAGE AND USE

(76) Inventor: Rick James Kroon, Portland, OR (US)

Correspondence Address: PARAMOUNT PATENTS, LLC, PMB 1477, 1122 EAST PIKE STREET, SEATTLE, WA, 98122, US

(21) Appl. No.: 11/421,729

(22) Filed: Jun. 1, 2006

(51) Int. Cl. A61J 19/00

(52) U.S. Cl. 4/259

(57) ABSTRACT

This invention relates generally to smokeless tobacco, and more specifically, to systems and methods for the use and storage of smokeless tobacco. In one embodiment, the invention includes a spittoon that includes a spittoon bucket and a spittoon cap. The spittoon cap is configured to be coupled to the spittoon bucket and the spittoon cap includes a tube, a first cap lip and a second cap lip. Additionally, the first cap lip and the second cap lip define a cap cavity, which is configured to hold a smokeless tobacco can. Furthermore, the tube is configured to provide a passage that allows matter to pass through the tube and be contained within the spittoon bucket.

### FIELD OF THE INVENTION

This invention relates generally to smokeless tobacco, and more specifically, to systems and methods for the use and storage of smokeless tobacco.

### BACKGROUND OF THE INVENTION

The tobacco plant has likely been growing in North and South America since about 6000 B.C., but the earliest documented used of the plant was as early as 1 B.C. by the Native American Indians who used it for both medicinal and religious practices. On Oct. 15th, 1492, Christopher Columbus was offered dried tobacco leaves as a gift by Native American Indians that he encountered during his exploration of the New World, and the plants eventually made their way to the England where they were first cultivated and used for medicinal and recreational purposes. In 1612 the first commercial crop of tobacco was grown in the Americas, and factories that produced smokeless tobacco began to appear in the 1730's. Ever since then, smokeless tobacco, chew, snuff or dip has been used recreationally by people around the world.

Smokeless tobacco is typically sold in round cans or tins, and although users have many ways of transporting the can, the most popular and famous method of transportation is in the back pocket of denim jeans, which creates a signature circular indentation in the user's jeans. Unfortunately, this method, along with many other methods of carrying smokeless tobacco can be uncomfortable and cumbersome.

Use of smokeless tobacco can generate large amounts of saliva in the mouth of a user, which typically requires a user to expectorate or spit quite frequently. Some users will expectorate onto the ground; however, in many cultures this is socially unacceptable and therefore a user will typically expectorate into some sort of container. Typically, a user will spit into a used bottle, can or cup. This method is not desirable because most used bottles, cups or cans are not configured to allow easy and stable storage or transportation of a user's expectorant. These containers can easily spill, especially in cars, and may not have a means of capping or plugging the opening of the container, which allows odors of the expectorant to escape into the surrounding environment in addition to creating a spilling hazard. Therefore, it is difficult for a user to discretely use smokeless tobacco products around others.

Additionally, along with being prone to spillage and obtrusiveness, containers that are typically used by smokes tobacco users do not have a means of carrying the smokeless tobacco can along with the container. Therefore, what are needed are systems and methods for the use and storage of smokeless tobacco.

### SUMMARY OF THE INVENTION

This invention relates generally to smokeless tobacco, and more specifically, to systems and methods for the use and storage of smokeless tobacco. In one embodiment, the invention includes a spittoon that has a spittoon bucket and a spittoon cap. The spittoon cap is configured to be coupled to the spittoon bucket and the spittoon cap includes a tube, a first cap lip and a second cap lip. Additionally, the first cap lip and the second cap lip define a cap cavity, which is configured to hold a smokeless tobacco can. Furthermore, the tube is configured to provide a passage that allows matter to pass through the tube and be contained within the spittoon bucket.

In further embodiments, the spittoon includes one or more cap wing, one or more cap hole, one or more indentation, a plug coupling aperture, a plug coupling notch, one or more bucket handle, and a cap flange. In other embodiments, the spittoon further includes a spittoon cap plug that can be configured to be coupled to the spittoon cap.

### BRIEF DESCRIPTION OF THE DRAWINGS

Embodiments of the present invention are described in detail below with reference to the following drawings:

FIG. 1 is an environmental view of the spittoon, in accordance with an embodiment of the invention;

FIG. 2 is a front view of the spittoon cap and spittoon cap plug, in accordance with an embodiment of the invention;

FIG. 3 is a bottom view of the spittoon cap plug, in accordance with an embodiment of the invention;

FIG. 4 is a bottom view of the spittoon cap, in accordance with an embodiment of the invention;

FIG. 5 is a side view of the spittoon cap, in accordance with an embodiment of the invention;

FIG. 6 is a top view of the spittoon cap, in accordance with an embodiment of the invention;

FIG. 7 is a side view of the spittoon bucket, in accordance with an embodiment of the invention;

FIG. 8 is a top view of the spittoon bucket, in accordance with an embodiment of the invention; and

FIG. 9 is close-up view of the first and second cap coupling member, in accordance with an embodiment of the invention.

### DETAILED DESCRIPTION

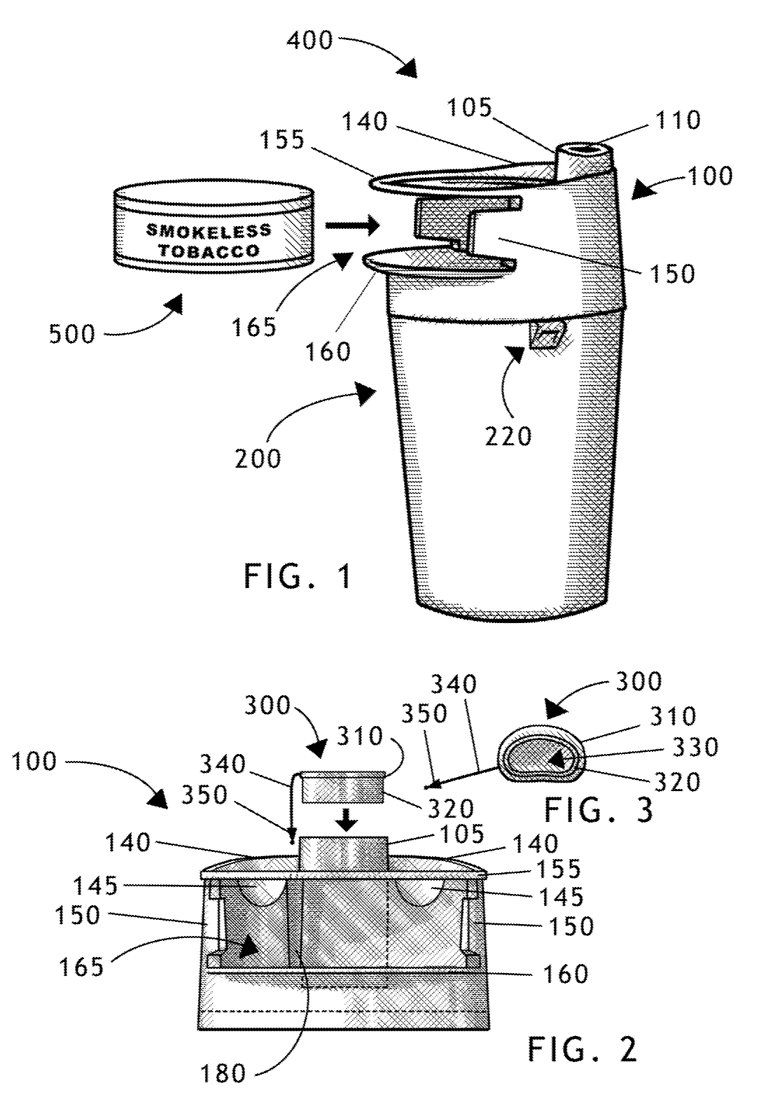

This invention relates generally to smokeless tobacco, and more specifically, to systems and methods for the use and storage of smokeless tobacco. Specific details of certain embodiments of the invention are set forth in the following description and in FIGS. 1-9 to provide a thorough understanding of such embodiments. The present invention may have additional embodiments, or may be practiced without one or more of the details described for any particular described embodiment.

FIG. 1 is an environmental view of a spittoon 400, in accordance with an embodiment of the invention. FIG. 1 depicts the spittoon 400, which comprises a spittoon cap 100 coupled to a spittoon bucket 200. The spittoon cap 100 comprises a tube 105, tube orifice 110, a cap flange 140, one or more cap wing 150, a first cap lip 155, a second cap lip 160, and a cap cavity 165. The spittoon bucket 200 comprises one or more bucket handle 220.

In one embodiment, the cap cavity 165 is defined by, among other elements, the first cap lip 155, the second cap lip 160 and one or more cap wing 150. The elements defining the cap cavity 165 can be configured such that the cap cavity 165 can receive and hold and receive a smokeless tobacco can 500. To achieve the reception and holding of the smokeless tobacco can 500, in one embodiment, there is a first and second cap wing 150, which can be configured such that the distance between the first and second wing 150 is less than the diameter of the smokeless tobacco can 500.

To place the smokeless tobacco can 500 in the cap cavity 165, a user first places the smokeless tobacco can 500 between the first cap lip 155 and the second cap lip 160, thereby inserting the smokeless tobacco can 500 partially into cap cavity 165. The user then presses on the smokeless tobacco can such that a force is applied to the first and second cap wing 150, the force pushes the first and second cap wing 150 away from each other such that the distance between the first and second cap wing 150 is equal or greater than the diameter of the smokeless tobacco can 500. The user finally pushes the on the smokeless tobacco can 500 such that the smokeless tobacco 500 can is fully inserted into the cap cavity 165. The tobacco can 500 is held in the cap cavity 165 by the first and second cap wing 150.

In this embodiment, the first and second cap wing 150 are configured to be semi-elastic or are made of a material that makes them semi-elastic. The semi-elastic property of the first and second cap wing 150 allows the first and second cap wing 150 to flex or bend when force is applied to the first and second cap wing 150, but allows the first and second cap wing 150 to return to their original shape or position when force is removed.

In a further embodiment the there can be one or more cap wing 150 and the one or more cap wing 150 can be made of any material such as plastic, metal, glass, wood, rubber textile, or ceramic. In a still further embodiment the one or more cap wing 150 can be in any shape. In another embodiment, the one or more cap wing 150 can comprise springs, rods, or other mechanical means that allow the one or more cap wing 150 to be configured such that the cap cavity 165 can accept and hold a smokeless tobacco can 500.

In one embodiment, the first cap lip 155 and the second cap lip 160 are configured such that a smokeless tobacco can 500 is capable of being inserted into the cap cavity 165 and held within the cap cavity 165. The distance between the first cap lip 155 and the second cap lip 160 can be equal of less than the height of a smokeless tobacco can 500. To insert the tobacco can 500 into the cap cavity 165, the user can increase the distance between the first cap lip 155 and the second cap lip 160 by prying, pulling or lifting one or both of the first cap lip 155 and the second cap lip 160 such that the smokeless tobacco can is capable of being inserted into the cap cavity 165. Once the can is inserted, the first cap lip 155 and/or the second cap lip 160 can be released so that smokeless tobacco can 500 is held within the cap cavity 165. The first cap lip 155 and the second cap lip 160 can be made of an elastic or semi-elastic material such that the first cap lip 155 and the second cap lip 160 will exert a force on the smokeless tobacco can 500 in the cap cavity 165 and thereby hold the smokeless tobacco can 500 in the cap cavity 165.

In a further embodiment, the first cap lip 155 and the second cap lip 160 can be any shape or size and can be any distance apart. In a still further embodiment, the first cap lip 155 and the second cap lip 160 can be made of any material, including, but not limited to plastic, metal, glass, wood, rubber textile, or ceramic.

In one embodiment of the invention a user can expectorate or spit into tube orifice 110 of the tube 105, which can be configured to allow the expectorant or spit to flow into and be held within the spittoon bucket 200. A user can expectorate or spit any fluid into the tube orifice 110 of the tube 105, which can comprise one or more of the following materials: saliva, water, or smokeless tobacco.

In a further embodiment, a user may expectorate, spit or place any material into the tube orifice 110 of the tube 105, so that it can be held in the spittoon bucket 200. These materials include, but are not limited to cigarettes, cigarette butts, smokeless tobacco, or paper.

In a still further embodiment a user may place any fluid, material, or object into the tube orifice 110 of the tube 105 so that this material can be held within the spittoon bucket. The user can then drink, ingest, imbibe, pour or remove said fluid, material or object though the tube orifice 110 of the tube 105. Such fluid, material, or object can be, but is not limited to water, juice, sports drink, beer, candy, peanuts, paper clips or coins.

FIG. 2 is a front view of the spittoon cap 100 and spittoon cap plug 300, in accordance with an embodiment of the invention. FIG. 2 depicts the spittoon cap 100, which comprises a tube 105, a cap flange 140, an indentation 145, one or more cap wing 150, a first cap lip 155, a second cap lip 160, a cap cavity 165, and a plug coupling notch 180. FIG. 2 further depicts a spittoon cap plug 300, which comprises a plug cap 310, a plug rim 320, a plug extension member 340 and a plug coupling member 350.

In one embodiment of the present invention, the spittoon cap plug 300 can be inserted into the tube orifice 110 (not shown in FIG. 2) of the tube 105. The plug rim 320 can be configured to be the same or similar shape and size of the tube orifice 110 (not shown in FIG. 2) such that the spittoon cap plug can be inserted into the tube orifice 110 (not shown in FIG. 2). In a further embodiment the spittoon cap plug 300 forms a seal, which is achieved by contact or friction between the plug rim 320 and the interior of the tube 105, which defines the tube orifice 110 (not shown in FIG. 2). In a still further embodiment, the spittoon cap plug 300 is held on the top of the tube 105 or prevented from sliding down the tube 105 by the plug cap 310. In one embodiment the plug cap 310 can be the width of the tube 105 such that the tube 105 is completely covered when the spittoon cap plug 300 placed in the tube orifice 110. In another embodiment, the tube cap 310 can be any size or shape, and may include extensions, lips, rims, or protrusions.

In one embodiment of the invention, the spittoon cap plug 300 is secured or coupled to the spittoon cap 100 by the plug extension member 340, and the plug coupling member 350, which interact with the plug coupling aperture 175 (not shown in FIG. 2) and the plug coupling notch. The plug coupling member 350 is made of an elastic or semi-elastic material that is configured such that it has a greater diameter than the plug coupling aperture 175 (not shown in FIG. 2). To secure, attach, or couple the spittoon cap plug 300 to the spittoon cap 100, the plug coupling member 350 is forced through a first end of the plug coupling aperture 175 (not shown in FIG. 2). The elastic or semi-elastic property of the plug coupling member 350 allows it to be compressed and thereby travel through the plug coupling aperture 175 (not shown in FIG. 2). Once the plug coupling member 350 passes through the plug coupling aperture 175 (not shown in FIG. 2), the plug coupling member 350 returns to or resumes its former shape, which thereby prevents it from passing back through the plug coupling aperture 175 (not shown in FIG. 2).

Once the plug coupling member 350 has passed through the plug coupling aperture 175 (not shown in FIG. 2), the plug coupling member 350 and the plug extension member 340 may reside and move about in the plug coupling notch 180. In a further embodiment, the plug coupling notch 180 may be any size or shape.

In a still further embodiment, the spittoon orifice 105 may be plugged by any means, including, but not limited to, a cap that is placed around the tube, a valve, a clasp, or Velcro®. In another embodiment, the spittoon cap plug 300 can be attached or coupled to the spittoon in any way, including, but not limited to, a clasp, welding, ball and socket, tape, hinge, string tether, rope tether, glue, or it can be formed as an integral member of the spittoon cap 100.

FIG. 3 is a bottom view of the spittoon cap plug 300, in accordance with an embodiment of the invention, which comprises a plug cap 310, a plug rim 320, a plug orifice 330, a plug extension member 340 and a plug coupling member 350. In on embodiment, the plug orifice 330 is not present. In a further embodiment, the spittoon cap plug 300 can be any shape, size, length, or configuration and may be made of any material, including, but not limited to plastic, metal, glass, wood, rubber textile, cork, or ceramic.

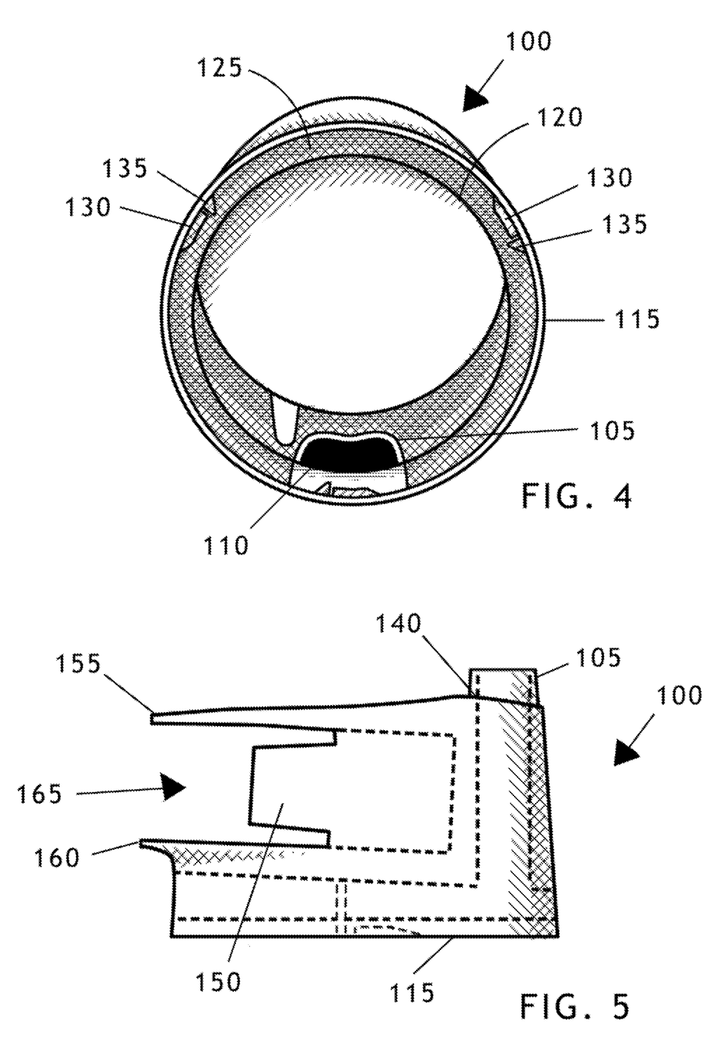

FIG. 4 is a bottom view of a spittoon cap 100, in accordance with an embodiment of the invention, which comprises a tube 105, a tube orifice 110, an outer cap rim 115, an inner cap rim 120, a cap slot 125, a first cap coupling member 130, and a second cap coupling member 135.

On the interior of the outer cap rim 115 there is one or more first cap coupling member 130 and one or more second cap member 135, which can be configured to couple the spittoon cap 100 to the spittoon bucket 200 (not shown in FIG. 4). Additionally, the circumference of the interior of the outer cap rim 115 is configured to be equal to or greater than the circumference of the exterior of the bucket rim 205 (not shown in FIG. 4) and the cap slot 125, which is defined by the inner cap rim 120 and the outer cap rim 115, can be configured to allow the bucket rim 205 (not shown in FIG. 4) to reside within the cap slot 125.

As described herein, the tube 105 is configured to provide a tube orifice 110 from a first end to a second end of the spittoon cap 100, which can facilitate the passage of fluids, solids or gasses through the tube orifice 110. In one embodiment of the invention, the tube 105 can be any shape, such as a square, rectangle, oval, circle, or any other regular or irregular shape and the length of the tube 105 may be regularly or irregularly shaped at different points along the tube 105. In a further embodiment, there can be one or more tube 110.

FIG. 5 is a side view of the spittoon cap 100, in accordance with an embodiment of the invention, which comprises a tube 105, an outer cap rim 115, a cap flange 140, one or more cap wing 150, a first cap lip 155, a second cap lip 160, and a cap cavity 165.

FIG. 6 is a top view of the spittoon cap 100, in accordance with an embodiment of the invention, which comprises a tube 105, a tube orifice 110, a cap flange 140, one or more indentation 145, a first cap lip 155, one or more cap hole 170, and a plug coupling aperture 175.

In one embodiment, there is a first and a second cap hole 170, which is positioned symmetrically near the edge of the first cap lip 155. The first and second cap hole 170 are defined by a hole in the first cap lip 155 and provide a passage into the cap cavity 165 (not shown in FIG. 6). The first and second cap hole 170 is elongated, with a bulbous end that is roughly circular. Additionally, the first and second cap hole 170 is configured to provide a passage to the indentation 145, which is located in and defines the cap cavity 165 (not shown in FIG. 6).

When a smokeless tobacco can 500 resides or is held in the cap cavity 165 (not shown in FIG. 6), a user can manipulate or apply force to the smokeless tobacco can 500 through the first and second cap hole 170, such that the smokeless tobacco can 500 is removed, ejected or dislodged from the cap cavity 165 (not shown in FIG. 6). To facilitate the removal, ejectment or dislodgement of the smokeless tobacco can 500, the user puts a first finger through the first cap hole 170 and/or a second finger through the second cap hole 170. The indentation 145 allows the user to access and thereby manipulate or apply force to the smokeless tobacco can 500 and thereby remove, eject or dislodge the smokeless tobacco can 500 from the cap cavity 165 (not shown in FIG. 6).

In another embodiment, there can be one or more cap hole 170, which can be any size or shape and can be located anywhere on the first cap lip 155. In a further embodiment, there may be one or more indentation 145, which can be accessed through the one or more cap hole 170 on the first cap lip 155. In a still further embodiment, there can be one or more indentation, which can be in any shape or configuration.

As described herein, the plug coupling aperture 175 facilitates the coupling or attachment of the spittoon cap plug 300 to the spittoon cap 100. In one embodiment, the cap coupling aperture 175 can be any shape or size.

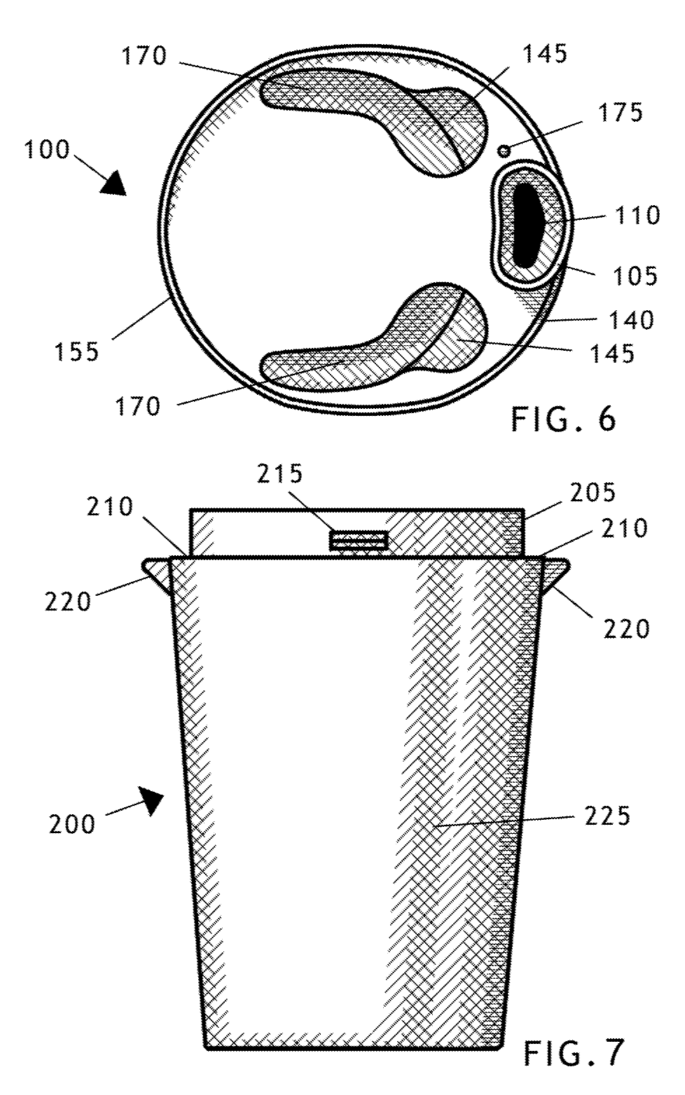

FIG. 7 is a side view of a spittoon bucket 200, in accordance with an embodiment of the invention, which comprises a bucket rim 205, a bucket shelf 210, one or more bucket coupling member 215, one or more bucket handle 220, and a bucket body 225.

In one embodiment of the invention, the bucket body 225 can be any size or shape, either regular or irregular. In a further embodiment, the bucket rim 205 can be any shape or size, either regular or irregular. In a still further embodiment, there may be one or more bucket handle 220, which may be configured to allow a user to grasp or hold the bucket handle 220. In a still further embodiment, there may be one or more bucket handle 220, which may be configured to accept a strap, clip, rope, string, band or other coupling means. The strap, clip, rope, string, band, or other coupling means can be connected to one or more bucket handle 220.

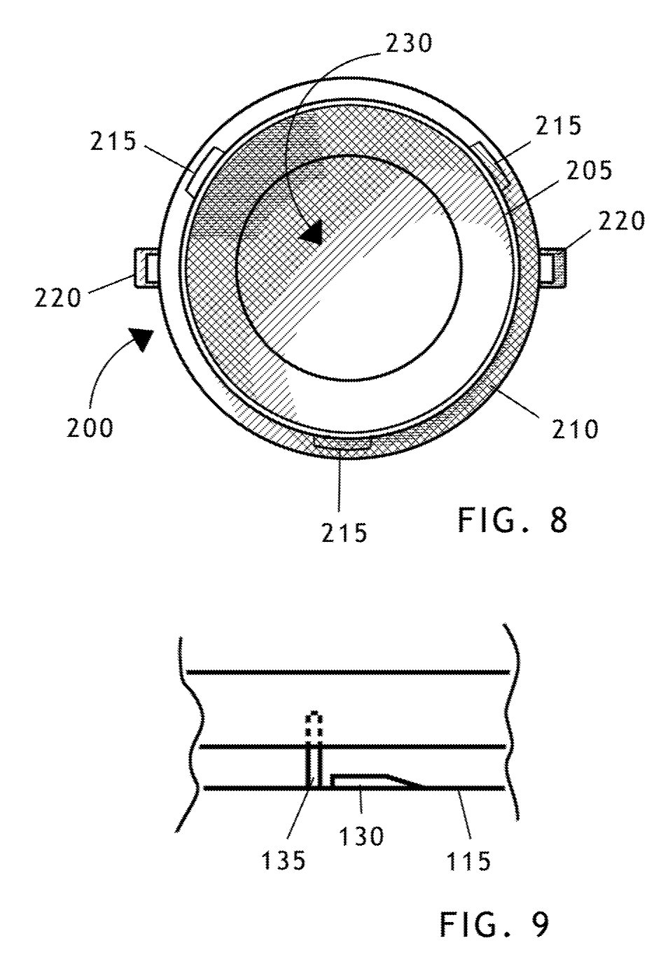

FIG. 8 is a top view of the spittoon bucket 200, in accordance with an embodiment of the invention, which comprises a bucket rim 205, bucket shelf 210, one or more bucket coupling member 215, one or more bucket handle 220, and a bucket orifice.

FIG. 9 is close-up view of the first cap coupling member 130 and the second cap coupling member 135, in accordance with an embodiment of the invention. In one embodiment of the invention there can be one or more first cap coupling member 130 and one or more second cap coupling member 140. The first cap coupling member 130 and the second cap coupling member 135 facilitate the coupling or attachment of the spittoon cap 100 to the spittoon bucket 200. Coupling or attachment of the spittoon cap 100 to the spittoon bucket 200 is achieved when the spittoon cap 100 is placed onto the spittoon bucket 200 such that the bucket rim 205 resides within the cap slot 125, which is defined by the outer cap rim 115 and the inner cap rim 120, and such that the outer cap rim 120 rests on the bucket shelf 210. (elements shown and described herein, but not in FIG. 9) The spittoon cap 100 can then be rotated, while resting on the bucket shelf 210 such that the bucket coupling member rests on the first cap coupling member 130 and comes to rest against the second cap coupling member 135, which facilitates a seal between outer cap rim 115 and the bucket shelf 210 and couples the spittoon cap 100 to the spittoon bucket 200.

In another embodiment of the invention, the first cap coupling member 130 and the second cap coupling member 135 can be any size or shape. In a still further embodiment, there may be a material on the bucket shelf and/or the outer cap rim 115 that facilitates a seal, such as rubber, plastic or textile. In a still further embodiment of the invention, coupling of the spittoon cap 100 to the spittoon bucket 200 can be achieved through any means of coupling known in the art, including, but not limited to complementary screw, pin and slot, ball and socket, latch, or friction.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

What is claimed is:

1. A spittoon, the spittoon comprising:
(a) a spittoon bucket; and
(b) a spittoon cap, the spittoon cap being configured to be coupled to, the spittoon bucket, the spittoon cap including
(i) a tube;
(ii) a first cap lip; and
(iii) a second cap lip,
wherein the first cap lip and the second cap lip define a cap cavity, the cap cavity configured to hold a smokeless tobacco can and wherein the tube is configured to provide a passage that allows matter to pass through the tube and be contained within the spittoon bucket.

2. The spittoon of claim 1, wherein the spittoon cap further comprises one or more cap wing.

3. The spittoon of claim 1, wherein the spittoon cap further comprises one or more cap hole.

4. The spittoon of claim 1, wherein the spittoon cap further comprises one or more indentation.

5. The spittoon of claim 1, wherein the spittoon cap further comprises a plug coupling aperture and a plug coupling notch.

6. The spittoon of claim 1, wherein the spittoon bucket further comprises one or more bucket handle.

7. The spittoon of claim 1, wherein the spittoon cap further comprises a cap flange.

8. The spittoon of claim 1, wherein the spittoon further comprises a spittoon cap plug, the spittoon cap plug being configurable to reside in the tube.

9. The spittoon of claim 8, wherein the spittoon cap plug is further configurable to be coupled to the spittoon cap.

10. A spittoon cap, the spittoon cap comprising:
(i) a tube;
(ii) a first cap lip; and
(iii) a second cap lip,
wherein the first cap lip and the second cap lip define a cap cavity, the cap cavity configured to hold a smokeless tobacco can.

11. The spittoon of claim 10, wherein the spittoon cap further comprises one or more cap wing.

12. The spittoon of claim 10, wherein the spittoon cap further comprises one or more cap hole.

13. The spittoon of claim 10, wherein the spittoon cap further comprises one or more indentation.

14. The spittoon of claim 10, wherein the spittoon cap further comprises a plug coupling aperture and a plug coupling notch.

15. The spittoon of claim 10, wherein the spittoon cap further comprises a cap flange.

16. The spittoon of claim 10, wherein the spittoon further comprises a spittoon cap plug, the spittoon cap plug being configurable to reside in the tube.

17. The spittoon of claim 16, wherein the spittoon cap plug is further configurable to be coupled to the spittoon cap.

18. A spittoon cap, the spittoon cap comprising:
(i) a tube;
(ii) a first cap lip;
(iii) a second cap lip; and
(iv) one or more cap wing,
wherein the first cap lip, the second cap lip, and the one or more cap wing define a cap cavity, the cap cavity configured to hold a smokeless tobacco can.

19. The spittoon of claim 10, wherein the spittoon cap further comprises one or more cap hole.

20. The spittoon of claim 10, wherein the spittoon cap further comprises one or more indentation.
